(19) United States
(12) Patent Application Publication
(10) Pub. No.: US 2016/0305468 A1
(43) Pub. Date: Oct. 20, 2016

(54) VACUUM ADSORPTION APPARATUS

(71) Applicant: Hong Sik KOO, Seoul (KR)

(72) Inventor: Hong Sik KOO, Seoul (KR)

(21) Appl. No.: 15/193,130

(22) Filed: Jun. 27, 2016

Related U.S. Application Data
(63) Continuation of application No. PCT/KR2015/000169, filed on Jan. 8, 2015.

(30) Foreign Application Priority Data
Jan. 8, 2014 (KR) 10-2014-0002214
Jun. 23, 2014 (KR) 10-2014-0076202

(51) Int. Cl. F16B 47/00; F16M 13/02

(52) U.S. Cl. CPC F16B 47/00; F16M 13/022

(57) ABSTRACT

A vacuum suction device is disclosed. The vacuum suction device includes a suction member that is brought into vacuum-suction contact with an attachment surface by a vacuum chamber formed therein and an adjustment member that is coupled to the suction member to form the vacuum chamber. The suction member includes a first hard-material portion that is coupled to the adjustment member and that is raised by the adjustment member, a deformable portion of which one end is connected to an end of the first hard-material portion and that is deformable in shape, and a second hard-material portion that is connected to the other end of the deformable portion to support the deformable portion and is located outside the first hard-material portion.

### CROSS-REFERENCE TO RELATED APPLICATIONS

This application claims the benefit under 35 U.S.C. §120 and §365(c) to a prior PCT International Application No. PCT/KR2015/000169, filed on Jan. 8, 2015, which claims the benefit of Korean Patent Application No. 10-2014-0002214, filed on Jan. 8, 2014, and Korean Patent Application No. 10-2014-0076202 filed in the Korean Intellectual Property Office on Jun. 23, 2014, the entire contents of which are incorporated herein by reference.

### TECHNICAL FIELD

The present invention relates to a vacuum suction device, and more particularly, to a vacuum suction device with a simple structure.

### BACKGROUND ART

A vacuum suction device means a device that can be attached to another object by vacuum generated in the device. Such a vacuum suction device is mainly used to attach a certain object to glass, tiles, or the like without using a nail, an adhesive, or the like.

FIGS. 1 and 2 are cross-sectional views illustrating a vacuum suction device according to the related art, where FIG. 1 illustrates a state in which a suction plate 10 is flatly brought into close contact with an attachment surface s and FIG. 2 illustrates a state in which the suction plate 10 rises to form a vacuum chamber c between the suction plate 10 and the attachment surface s.

Referring to FIGS. 1 and 2, the vacuum suction device according to the related art includes a soft suction plate 10 that is brought into close contact with an attachment surface S, a hard pressing cap 20 that covers the suction plate 10 with a predetermined gap G at the center while pressing a top edge portion of the suction plate 10, a pulling rod 30 that is disposed at the center of the top surface of the suction plate 10 and penetrates the pressing cap 20, and a fastening tool 40 that is screwed to the pulling rod 30 to pull upward the pulling rod 30 by rotation.

When the suction plate 10 is brought into close contact with the attachment surface s and then the fastening tool 40 is rotated while pressing the pressing cap 20 downward, the pulling rod 30 screwed to the fastening tool 40 rises to form a vacuum chamber c in an extra-low pressure state between the attachment surface s and the suction plate. The vacuum suction device is suctioned to the attachment surface s by a vacuum suction force of the vacuum chamber c formed in this way.

The vacuum suction device according to the related art includes the soft suction plate 10 which is formed of a rubber material which can freely contract and extend, the pressing cap 20 and the pulling rod 30 which are formed of a hard material, and the fastening tool 40 that is screwed to the pulling rod 30 and formed of a hard material. Particularly, since the soft suction plate 10 and the hard pulling rod 30 are different from each other in material, the suction plate and the pulling rod should be manufactured separately and then should be coupled to each other. Accordingly, there is a problem in that a manufacturing cost increases and a manufacturing time also increases.

### CITATION LIST

### Patent Literature

Korean Unexamined Utility Model Application Publication No. 20-2010-0003866

### SUMMARY OF THE INVENTION

### Technical Problem

Therefore, the present invention is conceived to solve the above-mentioned problem and is directed to providing of a vacuum suction device with a simple structure which can reduce manufacturing cost and time.

Other objects of the present invention will be more apparent from embodiments to be described below.

### Solution to Problem

According to an aspect of the present invention, there is provided a vacuum suction device including: a suction member that is brought into vacuum-suction contact with an attachment surface by a vacuum chamber formed therein; and an adjustment member that is coupled to the suction member to form the vacuum chamber, wherein the suction member includes a first hard-material portion that is coupled to the adjustment member and that is raised by the adjustment member, a deformable portion of which one end is connected to an end of the first hard-material portion and that is deformable in shape, and a second hard-material portion that is connected to the other end of the deformable portion to support the deformable portion and is located outside the first hard-material portion.

The vacuum suction device according to the aspect of the present invention may have one or more of the following features. For example, an adjustment protrusion may be formed to protrude from the first hard-material portion, and the adjustment member may be coupled to the adjustment protrusion by a screw of a pin or is integrally formed with the adjustment protrusion by injection molding.

The deformable portion may have a thickness smaller than that of the first hard-material portion or the second hard-material portion so as to be deformable in shape.

The first hard-material portion, the deformable portion, and the second hard-material portion may be integrally formed of the same material by injection molding.

An end of the suction member may be coupled to packing or be coated with a gel.

The deformable portion may be connected to the second hard-material portion via a rotation point and the first hard-material portion may be located lower than the rotation point.

The deformable portion may be connected to the first hard-material portion and may have a curved shape.

### Advantageous Effects of the Invention

According to the present invention, it is possible to provide a vacuum suction device with a simple structure which can reduce manufacturing costs and time.

### BRIEF DESCRIPTION OF THE DRAWINGS

FIG. 1 is a cross-sectional view illustrating a vacuum suction device according to the related art and illustrating a state in which a suction plate is brought into close contact with an attachment surface.

FIG. 2 is a cross-sectional view illustrating the vacuum suction device according to the related art and illustrating a state in which the suction plate is separated from the attachment surface.

FIG. 3 is a perspective view illustrating a vacuum suction device according to a first embodiment of the present invention.

FIG. 4 is a top view of the vacuum suction device illustrated in FIG. 3.

FIG. 5 is a cross-sectional view of the vacuum suction device taken along line A-A in FIG. 3.

FIG. 6 is a cross-sectional view illustrating a state in which a first hard-material portion rises to form a vacuum chamber in FIG. 5.

FIGS. 7 and 8 are cross-sectional views illustrating a vacuum suction device according to a second embodiment of the present invention.

FIGS. 9 and 10 are cross-sectional views illustrating a vacuum suction device according to a third embodiment of the present invention.

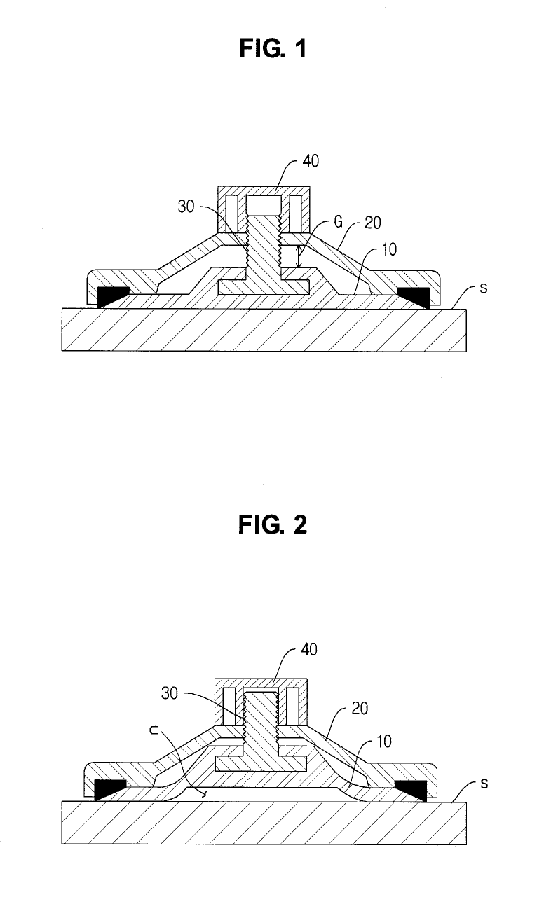

### DESCRIPTION OF EMBODIMENTS

The invention can be modified in various forms and can have various embodiments. Specific embodiments will be illustrated in the drawings and described in detail. However, the embodiments are not intended to limit the invention, but it should be understood that the invention includes all modifications, equivalents, and replacements belonging to the concept and the technical scope of the invention. When it is determined that detailed description of known techniques involved in the invention makes the gist of the invention obscure, the detailed description thereof will not be made.

The terms used in the following description are intended to merely describe specific embodiments, but not intended to limit the invention. An expression of the singular number includes an expression of the plural number, so long as it is clearly read differently. The terms such as “include” and “have” are intended to indicate that features, numbers, steps, operations, elements, components, or combinations thereof used in the following description exist and it should thus be understood that the possibility of existence or addition of one or more other different features, numbers, steps, operations, elements, components, or combinations thereof is not excluded.

Terms such as first and second can be used to describe various elements, but the elements should not be limited to the terms. The terms are used only for distinguishing one element from another element.

Hereinafter, embodiments of the invention will be described in detail with reference to the accompanying drawings. In describing the invention with reference to the accompanying drawings, like elements are referenced by like reference numerals or signs regardless of the drawing numbers and description thereof is not repeated.

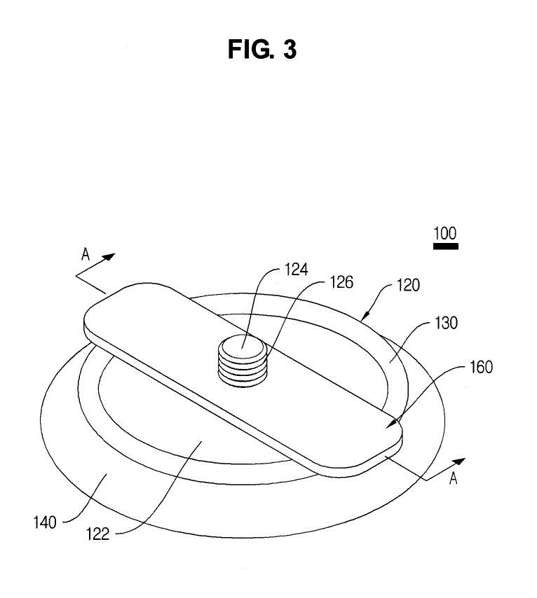

Hereinafter, a vacuum suction device 100 according to a first embodiment of the present invention will be described with reference to FIGS. 3 to 6.

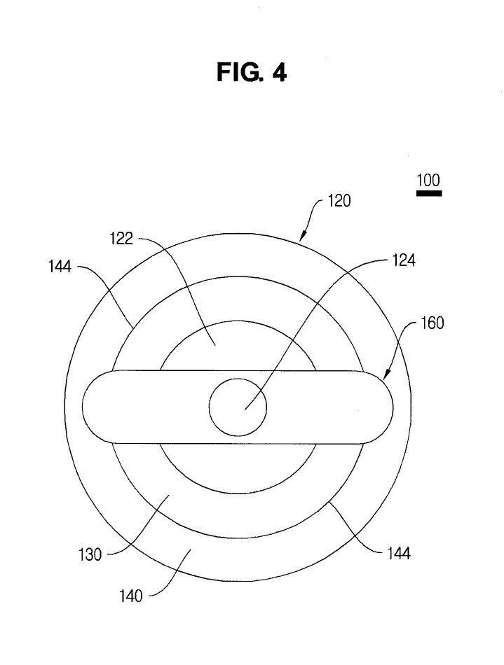

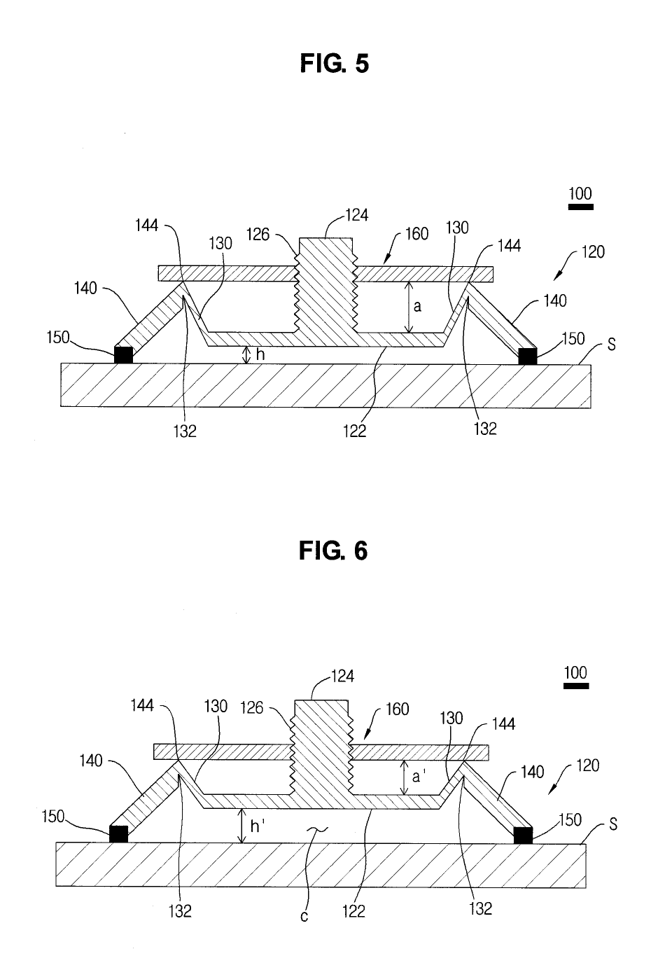

FIG. 3 is a perspective view illustrating the vacuum suction device 100 according to the first embodiment of the present invention. FIG. 4 is a top view of the vacuum suction device 100 illustrated in FIG. 3. FIG. 5 is a cross-sectional view of the vacuum suction device 100 taken along line A-A in FIG. 3. FIG. 6 is a cross-sectional view illustrating a state in which a first hard-material portion 122 rises to form a vacuum chamber in FIG. 5.

Referring to FIGS. 3 to 6, the vacuum suction device 100 according to the first embodiment includes a suction member 120 that is brought into vacuum-suction contact with an attachment surface s by a vacuum chamber c which is formed therein and an adjustment member 160 that is coupled to the suction member 120 to form the vacuum chamber c. The adjustment member 160 pulls a first hard-material portion 122 of the suction member 120 upward by rotation. Accordingly, an internal space of the suction member 120 is enlarged to form the vacuum chamber c in an extra-low pressure state and the suction member 120 is brought into close contact with the attachment surface s.

In this way, the vacuum suction device 100 according to the first embodiment includes two members of the suction member 120 and an adjustment protrusion 124 and thus has a merit that a configuration is simple. Particularly, since the suction member 120 is integrally formed of a single material, it is possible to achieve an effect that manufacturing cost and time can be reduced.

The suction member 120 is brought into vacuum-suction contact with the attachment surface s by a vacuum suction force which is formed by the vacuum chamber c therein. The suction member 120 includes a circular first hard-material portion 122 that is located at the center thereof, a ring-shaped deformable portion 130 that is formed around the first hard-material portion 122, a ring-shaped second hard-material portion 140 that is formed around the deformable portion 130, and packing 150 that is coupled to the lower end of the second hard-material portion 140.

The suction member 120 in this embodiment is exemplified to be circular, but the suction member may have shapes such as an elliptical shape and a polygonal shape. The present invention is not limited by the shape of the suction member 120.

The first hard-material portion 122, the deformable portion 130, and the second hard-material portion 140 may be integrally formed of the same material. For example, the suction member 120 may be integrally formed of a polypropylene resin by injection molding. The first hard-material portion 122 and the second hard-material portion 140 may be thicker than that of the deformable portion 130. For example, the first hard-material portion 122 and the second hard-material portion 140 may have a thickness of about 3 mm and the deformable portion 130 formed of the same material may have a thickness of about 0.1 mm to 0.7 mm.

In addition, the first hard-material portion 122 and the second hard-material portion 140 may be formed relatively thin. Particularly, the second hard-material portion 140 may be formed thin and then the position and the shape thereof may be maintained using another member such as a cover (not illustrated) that is coupled to the top of the suction member 120. The first hard-material portion 122 may also be formed relatively thin.

The first hard-material portion 122 and the second hard-material portion 140 have characteristics that deformation thereof will not be easily caused by an external force. Accordingly, even when the adjustment member 160 rotates, the first hard-material portion 122 and the second hard-material portion 140 are hardly deformed in shape. Here, the first hard-material portion 122 is coupled to the adjustment member 160 and is raised by the rotation of the adjustment member 160 or is lowered by a restoring force of the deformable portion 130.

The first hard-material portion 122 is located at the center of the suction member 120 and has a disk shape. Since the deformable portion 130 which is deformable in shape is coupled to the periphery of the first hard-material portion 122, the first hard-material portion 122 can be raised or lowered. The first hard-material portion 122 is raised by the rotation of the adjustment member 160. A vacuum chamber c is formed in the suction member 120 by the raising of the first hard-material portion 122 to generate a vacuum suction force. The first hard-material portion 122 is lowered by the restoring force of the deformable portion 130.

The adjustment protrusion 124 is formed at the center of the first hard-material portion 122. The adjustment protrusion 124 has a constant length and a thread 126 is formed on the periphery thereof. The adjustment member 160 is screwed to the adjustment protrusion 124. The adjustment member 160 moves upward or downward in the length direction of the adjustment protrusion 124 by the rotation thereof to directly raise the first hard-material portion 122 or to remove a force for pulling the first hard-material portion upward to lower the first hard-material portion.

The deformable portion 130 serves to connect the first hard-material portion 122 and the second hard-material portion 140. The deformable portion 130 is integrally formed of the same material as the first hard-material portion 122 and the second hard-material portion 140, but is relatively deformable with an external force due to its small thickness. Accordingly, an upward or downward force is applied to the first hard-material portion 122 by the rotation of the adjustment member 160 and the deformable portion 130 is deformed in shape to allow the first hard-material portion 122 to moves upward or downward.

The deformable portion 130 is exemplified to have a linear shape connecting the first hard-material portion 122 and the second hard-material portion 140, but the shape thereof may be modified in various forms depending on the shapes and the relative position of the first hard-material portion 122 and the second hard-material portion 140.

A rotation groove 132 is formed in a connection part of the deformable portion 130 and the second hard-material portion 140. The rotation groove 132 is formed to decrease the thickness of the connection part of the deformable portion 130 and the second hard-material portion 140. The deformable portion 130 can freely rotate and/or be deformed with respect to the second hard-material portion 140 due to the rotation groove 132.

The deformable portion 130 may have a curved shape as well as a linear shape. That is, the deformable portion 130 has a curved shape (for example, a V shape, a U shape, or an S shape) as a whole or may have partially a curved shape.

The second hard-material portion 140 is formed at the outermost edge of the suction member 120 and has a ring shape. The second hard-material portion 140 has characteristics that the shape thereof is hardly deformed with an external force, similarly to the first hard-material portion 122. Accordingly, the second hard-material portion 140 serves to support the first hard-material portion 122 and the adjustment member 160 while the first hard-material portion 122 is moving upward by the rotation of the adjustment member 160.

The second hard-material portion 140 of the suction member 120 according to this embodiment is exemplified to be disposed obliquely, but the second hard-material portion 140 may be disposed vertically. The second hard-material portion 140 is exemplified to have a linear shape, but may have various shapes such as a curved shape.

As illustrated in FIGS. 5 and 6, a pressing end 144 corresponding to the connection end of the second hard-material portion 140 and the deformable portion 130 protrudes upward to come in contact with the adjustment member 160. Since the second hard-material portion 140 is not deformed or hardly deformed with an external force, the adjustment member 160 always comes in contact with the pressing end 144 while the first hard-material portion 122 is moving upward.

A packing insertion groove (not referenced by a reference sign) is formed at the lower end of the second hard-material portion 140. Packing 150 is inserted into the packing insertion groove. The packing 150 is closely attached to the attachment surface s such that air does not flow into the internal space of the suction member 120.

The packing 150 may be formed of a material such as an adhesive gel, urethane, silicon, rubber, or soft PVC, but the present invention is not limited by the material of the packing 150. The packing 150 may be formed of adhesive elastomer or adhesive polyurethane. In this case, it is possible to further improve air-tightness between the suction member 120 and the attachment surface s to enhance suction endurance.

The packing 150 can be coupled to the lower end of the second hard-material portion 140 using various methods. For example, the packing 150 may be fused onto or inserted into the lower end of the second hard-material portion 140 or may be integrally formed by double injection molding.

The adjustment member 160 can pull the first hard-material portion 122 of the suction member 120 upward by the rotation thereof to enlarge the internal volume of the suction member 120, thereby forming a vacuum chamber c. The adjustment member 160 can fix the position of the first hard-material portion 122 to maintain the formed vacuum chamber c, thereby maintaining a vacuum suction force.

The adjustment member 160 has a rectangular plate shape and a through-hole (not referenced by a reference sign) formed at the center thereof is screwed to the adjustment protrusion 124 of the first hard-material portion 122. Accordingly, the adjustment member 160 moves upward and downward in the length direction of the adjustment protrusion 124 by the rotation thereof.

As illustrated in FIGS. 5 and 6, the adjustment member 160 comes in contact with the pressing end 144 of the second hard-material portion 140. Accordingly, when the adjustment member 160 rotates in one direction in the state illustrated in FIG. 5, the adjustment member 160 does not move upward and downward but the first hard-material portion 122 having the adjustment protrusion 124 formed therein moves upward. In this way, when the first hard-material portion 122 moves upward, the adjustment member 160 is not changed in height by the rotation.

In a state in which the packing 150 of the second hard-material portion 140 comes in close contact with the attachment surface s and the inner space of the suction member 120 is air-tightly sealed, when the first hard-material portion 122 moves upward to the state illustrated in FIG. 6 by the rotation of the adjustment member 160, the vacuum chamber c is formed to generate a vacuum suction force. Accordingly, the vacuum suction device 100 is brought into close contact with the attachment surface s.

In the vacuum suction device 100 according to this embodiment, the adjustment member 160 and the adjustment protrusion 124 are screwed to each other and the first hard-material portion 122 moves upward by the rotation of the adjustment member 160. However, the present invention may employ various structures for upward and downward movement of the first hard-material portion 122. For example, a lever structure in which the adjustment protrusion 124 (where the thread 126 is not formed on the periphery of the adjustment protrusion) is made to move upward using a principle of leverage may be employed.

When the first hard-material portion 122 moves downward by the backward rotation of the adjustment member 160, the extra-low pressure state in the vacuum chamber c can be released to easily detach the vacuum suction device 100 from the attachment surface s.

Now, usage of the vacuum suction device 100 according to the first embodiment will be described with reference to FIGS. 5 and 6. FIG. 5 illustrates a state in which the first hard-material portion 122 does not move upward and FIG. 6 illustrates a state in which the first hard-material portion 122 moves upward by the rotation of the adjustment member 160 to form the vacuum chamber c.

Referring to FIG. 5, when the first hard-material portion 122 does not move upward, a gap between the bottom surface of the first hard-material portion 122 and the attachment surface s is h which is the minimum, and a gap between the bottom surface of the adjustment member 160 and the top surface of the first hard-material portion 122 is a which is the maximum.

In the state illustrated in FIG. 5, the bottom surface of the first hard-material portion 122 may come in contact with the attachment surface s.

When the suction member 120 is pressed down against the attachment surface s, the internal space of the suction member 120 is sealed by the packing 150 and the suction member 120 cannot rotate with respect to the attachment surface s by the frictional force of the packing 150. When the adjustment member 160 rotates in this state, the adjustment protrusion 124 screwed to the adjustment member 160 moves upward and pulls the first hard-material portion 122 upward. Accordingly, as illustrated in FIG. 6, the gap between the bottom surface of the first hard-material portion 122 and the attachment surface s is h′ (>h) and the gap between the bottom surface of the adjustment member 160 and the top surface of the first hard-material portion 122 is a′ (<a).

When the first hard-material portion 122 moves upward by the rotation of the adjustment member 160 in the state in which the internal space of the suction member 120 sealed, the internal space of the suction member 120 is enlarged to form the vacuum chamber c. A vacuum suction force is generated by the vacuum chamber c and thus the vacuum suction device 100 comes in close contact with the attachment surface s. By changing a degree of rotation of the adjustment member 160, it is possible to adjust the vacuum suction force.

Even when the first hard-material portion 122 moves upward or downward, the second hard-material portion 140 is not deformed. Accordingly, the pressing end 144 corresponding to an end of the second hard-material portion 140 always has a constant height. Since the bottom surface of the adjustment member 160 is supported to have a constant height by the pressing end 144 and the through-hole (not referenced by a reference sign) formed at the center of the adjustment member 160 is coupled to the periphery of the adjustment protrusion 124, the adjustment member 160 can maintain the state illustrated in FIG. 6 by the frictional force.

When the adjustment member 160 is rotated in the opposite direction to detach the vacuum suction device 100 from the attachment surface s, the first hard-material portion 122 moves downward to release the vacuum chamber c by the restoring force of the deformable portion 130. Accordingly, the vacuum suction force due to the vacuum chamber c is removed and thus the vacuum suction device 100 can be easily detached from the attachment surface s.

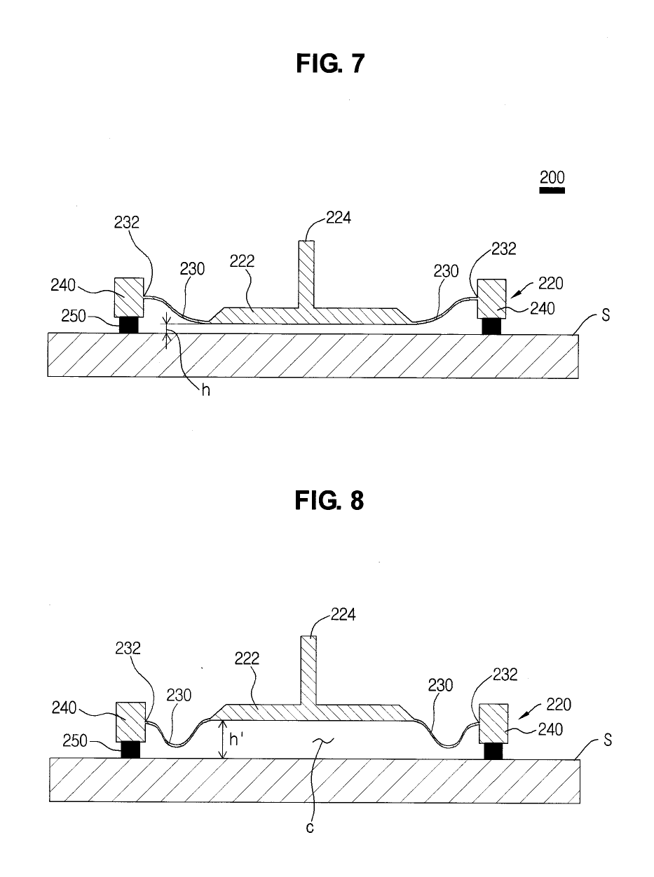

Now, a vacuum suction device 200 according to a second embodiment of the present invention will be described with reference to FIGS. 7 and 8.

FIGS. 7 and 8 are cross-sectional views illustrating the vacuum suction device 200 according to the second embodiment of the present invention, where FIG. 7 illustrates a state before a first hard-material portion 222 moves upward and FIG. 8 illustrates a state in which the first hard-material portion 222 has moved upward.

Referring to FIGS. 7 and 8, the vacuum suction device 200 according to this embodiment includes a first hard-material portion 222 that is located at the center, a second hard-material portion 240 that constitutes a periphery, and a deformable portion 230 that connects the first hard-material portion 222 and the second hard-material portion 240. An adjustment protrusion 224 is formed to protrude upward from the center of the first hard-material portion 222. Packing 250 is formed on the bottom of the second hard-material portion 240.

The adjustment member 160 of the vacuum suction device 100 according to the first embodiment can be coupled to the adjustment protrusion 224. The present invention is not limited by means for raising the first hard-material portion 222 and the first hard-material portion 222 can be raised by the principle of leverage.

The deformable portion 730 extends inside the second hard-material portion 240 and is connected to an end of the first hard-material portion 222 located at the center. In general, the deformable portion 230 can be integrally formed with the first hard-material portion 222 and the second hard-material portion 240 by plastic injection molding. The material of the deformable portion 230 is not stretched, but the shape thereof is deformed by an external force. The deformable portion 230 may have a thickness smaller than those of the first hard-material portion 222 and the second hard-material portion 240 so as to facilitate the deformation thereof.

Referring to FIG. 7, the deformable portion 230 has a curved shape when an external force is not applied thereto. At this time, the bottom surface of the first hard-material portion 222 is spaced apart by a height h from the attachment surface s, and this position corresponds to a position lower than a rotation point 232 corresponding to the connection point of the deformable portion 230 and the second hard-material portion 240.

When the first hard-material portion 222 moves upward in the state illustrated in FIG. 7, the first hard-material portion 222 and the second hard-material portion 240 are not deformed and the deformable portion 230 is deformed to allow the first hard-material portion 222 to move upward (see FIG. 8). The first hard-material portion 222 first hard-material portion 222 is spaced apart by h′ (>h) from the attachment surface s and thus a vacuum chamber c is formed between the attachment surface s and the first hard-material portion.

When the external force is removed in the state illustrated in FIG. 8, the deformable portion 230 is deformed to an original shape by the restoring force of the deformable portion 230 as illustrated in FIG. 7, and thus the first hard-material portion 222 moves downward to the state illustrated in FIG. 7.

The bottom surface of the first hard-material portion 222 is lower than the rotation point 232 before the first hard-material portion 222 moves upward, but this configuration is only an example. The present invention is not limited by the initial position of the first hard-material portion 222. Accordingly, the first hard-material portion may be located higher than the rotation point 232 before the first hard-material portion moves upward.

The upward-moving first hard-material portion 222 is located slightly higher than the rotation point 232, but this configuration is only an example. The present invention is not limited by the upward-moving position of the first hard-material portion 222. Accordingly, the upward-moving first hard-material portion may be located at a height lower than or equal to the rotation point 232.

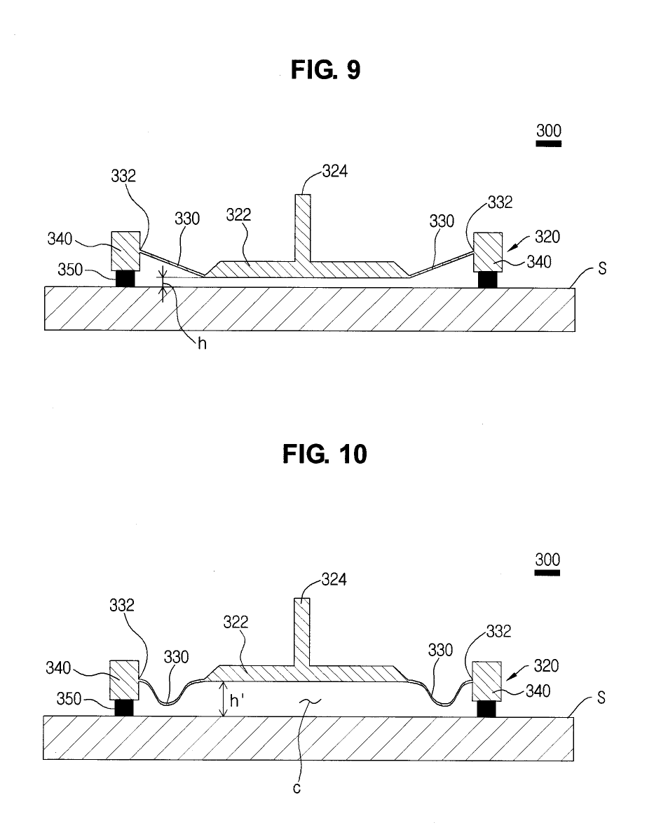

Now, a vacuum suction device 300 according to a third embodiment of the present invention will be described with reference to FIGS. 9 and 10.

FIGS. 9 and 10 are cross-sectional views illustrating the vacuum suction device 300 according to the third embodiment of the present invention, where FIG. 9 illustrates a state before a first hard-material portion 322 moves upward and FIG. 10 illustrates a state in which the first hard-material portion 322 has moved upward.

Referring to FIGS. 9 and 10, the vacuum suction device 300 according to the third embodiment of the present invention includes a first hard-material portion 322, a deformable portion 330, a second hard-material portion 340, and packing 350, which are similar to the first hard-material portion 222, the deformable portion 230, the second hard-material portion 240, and the packing 250 of the vacuum suction device 200 according to the second embodiment and thus specific description thereof will not be repeated. The deformable portion 330 of the vacuum suction device 300 according to this embodiment is characterized by having a linear shape when an external force is not applied thereto.

Referring to FIG. 9, the deformable portion 330 has a linear shape which is not deformed when an external force is not applied thereto. When an external force is applied vertically upward, the deformable portion 330 is deformed in a curved shape as illustrated in FIG. 10 to allow the first hard-material portion 322 to move upward. The first hard-material portion 322 moves upward from a height h to a height h′ (>h) with respect to an attachment surface s, whereby a vacuum chamber c is formed between the attachment surface s and the first hard-material portion.

In the vacuum suction devices 200 and 300 according to the second embodiment and the third embodiment, the packing 250 and 350 that is mounted on or attached to the bottoms of the second hard-material portions 240 and 340 may be attached in a rubber or gel type or may be integrally formed by double injection molding. The thicknesses of the second hard-material portions 240 and 340 may be set to be equal to or greater than those of the deformable portions 230 and 330, but the present invention is not limited thereto.

1. A vacuum suction device comprising:
a suction member that is brought into vacuum-suction contact with an attachment surface by a vacuum chamber formed therein; and
an adjustment member that is coupled to the suction member to form the vacuum chamber,
wherein the suction member includes a first hard-material portion that is coupled to the adjustment member and that is raised by the adjustment member, a deformable portion of which one end is connected to an end of the first hard-material portion and that is deformable in shape, and a second hard-material portion that is connected to the other end of the deformable portion to support the deformable portion and is located outside the first hard-material portion.

2. The vacuum suction device according to claim 1, wherein an adjustment protrusion is formed to protrude from the first hard-material portion, and
the adjustment member is coupled to the adjustment protrusion by a screw of a pin or is integrally formed with the adjustment protrusion by injection molding.

3. The vacuum suction device according to claim 1, wherein the deformable portion has a thickness smaller than that of the first hard-material portion or the second hard-material portion so as to be deformable in shape.

4. The vacuum suction device according to claim 1, wherein the first hard-material portion, the deformable portion, and the second hard-material portion are integrally formed of the same material by injection molding.

5. The vacuum suction device according to claim 1, wherein an end of the suction member is coupled to packing or coated with a gel.

6. The vacuum suction device according to claim 1, wherein the deformable portion is connected to the second hard-material portion via a rotation point and the first hard-material portion is located lower than the rotation point.

7. The vacuum suction device according to claim 1, wherein the deformable portion is connected to the first hard-material portion and has a curved shape.
